(19) United States
(12) Patent Application Publication
(10) Pub. No.: US 2010/0290417 A1
(43) Pub. Date: Nov. 18, 2010

(54) COMMUNICATION METHOD FOR MOBILE TERMINAL, NETWORK ADDRESS MANAGEMENT DEVICE AND MOBILE TERMINAL

(76) Inventors: Huasheng Lin, Beijing (CN); Bin Wei, Beijing (CN)

Correspondence Address: Vierra Magen Marcus & DeNiro LLP, 575 Market Street, Suite 2500, San Francisco, CA, 94105, US

(21) Appl. No.: 12/810,837

(22) PCT Filed: Nov. 25, 2008
(86) PCT No.: PCT/CN2008/001925

§ 371 Date: Jul. 8, 2010

(30) Foreign Application Priority Data
Dec. 28, 2007 (CN) 200710304490.4

(51) Int. Cl. H04W 8/00

(52) U.S. Cl. 370/329

(57) ABSTRACT

A Communication method for mobile terminal, a network address management device and a mobile terminal are provided, so as to solve the problem that the prior art couldn't select the communication mode flexibly based on the specific requirement. When the mobile terminal uses an application service to communicate with the correspondent, the following steps would be performed: obtaining a communication address which is assigned to be used by the application service, the communication address being the home address or the care-of address of the mobile terminal; when the obtained communication address being the home address, performing the communication with the correspondent by using the home address through the home agent; and when the obtained communication address being the care-of address, performing the communication with the correspondent by using care-of address. With above method, it is possible for mobile terminal to select communication mode autonomously, so as to satisfy the requirement of the communication privacy for the various mobile terminal and the requirement of the time delay for a variety of applications.

### FIELD OF THE INVENTION

The present invention relates to the field of communications and particularly to a communication method for a mobile terminal, a network address management device, and a mobile terminal.

### BACKGROUND OF THE INVENTION

The Mobile Internet Protocol (MIP) is a solution for providing mobile functions over the Internet. The solution enables a node to keep ongoing communication even during link switching, and is mainly designed to enable a mobile node to maintain continuity of communication when the mobile node enters into a foreign network.

A Home Address (HoA) is used for communication in the MIP and is transparent to an upper-layer protocol. The upper-layer protocol or application may use the Home Address of a mobile terminal, but the Care-of Address (CoA) is invisible to the upper-layer protocol or application. The so-called HoA is an address assigned to a mobile terminal connected to a home link, the so-called CoA is an address used by a mobile terminal connected to a foreign link, the HoA and the CoA are bound at a Home Agent (HA), which is generally a router in the home link and stores registration information and the current address of a mobile terminal away from the home link.

The MIP provides an IP routing mechanism which enables a mobile terminal to connect to any link with a permanent IP address (HoA) and to communicate using the HoA in any network. MIP communication is as shown in FIG. 1, the HoA and the CoA are bound at the HA and an IP packet of an upper-layer protocol or application (the source address of the packet is the HoA) is encapsulated through a bidirectional tunnel, i.e., a data packet tunnel established by the HA between the mobile terminal and a peer communication node (the source address of the encapsulated packet is the CoA), so that the IP packet is sent by the mobile terminal to the HA for decapsulation, and forwarded to the peer communication node by the HA according to the HoA. The above process and the CoA are invisible to the upper-layer application.

Taking advantage of the MIP by a mobile terminal to communicate in a foreign network brings the following advantages.

The HoA is used by the upper-layer application, and the mobile terminal communicate via the home network (e.g., an enterprise network), which is favorable for development of home network applications (e.g., enterprise applications). On one hand, a MIP user (i.e. an enterprise user) may access a variety of application servers in the home network (e.g. the enterprise network) with a fixed HoA regardless of its location; on the other hand, the home network can authorize and authenticate the access made by the user; in addition, since user data packets are routed through the home network, it is favorable for the home network (e.g. the enterprise network) to monitor and manage user communication and behaviors. Since the HoA is fixed, the service connection is maintained in the case of a change of the access network, and seamless roaming and switching can be achieved easily.

Corresponding to the above advantages, taking advantage of the MIP by a mobile terminal to communicate in a foreign network also brings the following drawbacks.

With the use of the MIP, data is communicated through the home network (e.g. the enterprise network), therefore all data and applications may be monitored, which is disadvantageous for the protection of user privacy, particularly for the application of some personal communicators such as MSN. In addition, since all communication is routed through the home network, alternate routing may occur and it is adverse to provision of real-time services.

If a user in a foreign network uses the CoA instead of the MIP to communicate directly, there is no drawback related to the MIP, though the advantages brought about by the MIP are unavailable. Advantages and drawbacks of communications using the MIP and not using the MIP by a mobile terminal in a foreign network are shown in the following Table 1 for comparison.

TABLE 1

| | Advantage | Drawback |
|---|---|---|
| Use the HoA for | 1. Favorable for access to | 1. Unable to protect privacy of user |
| communication | applications in the home network; | communication; |
| | 2. Favorable for user authorization | 2. Alternate routing, adverse to |
| | and authentication in the home | provision of real-time services; |
| | network, and for monitoring and | |
| | management of user communication | |
| | and behaviors; | |
| | 3. Service connection is maintained | |
| | in the case of a change of an access | |
| | point (i.e., seamless roaming and | |
| | switching); | |
| Use the CoA for | 1. Ensure privacy of user | 1. Adverse to access to applications in |
| communication | communication; | the home network; |
| | 2. No alternate routing, favorable for | 2. Adverse to user authorization and |
| | provision of real-time services; | authentication in the home network, |
| | | adverse to monitoring and |
| | | management of user communication |
| | | and behaviors; |
| | | 3. Continuous service connection can |
| | | not be maintained in the case of a |
| | | change of an access point; |

A user generally owns two identities, that is, the user not only is an enterprise user, but also has a demand for private personal communications; further, some applications require a seamless switching feature (e.g., applications sensitive to seamless switching), while some other applications require the smallest communication delay (e.g., applications sensitive to end-to-end time delay). However, in existing MIP applications, the CoA is usually shielded by the HoA, consequently, a user uses merely the HoA to communicate, and cannot use the CoA for direct communication, which is adverse to the development of privacy applications or any application sensitive to end-to-end time delay; whereas, when the MIP is disabled, the user uses merely the CoA to communicate, which is adverse to the development of enterprise applications or any application sensitive to seamless switching.

In view of the above, in scenarios where a user needs to communicate with variety identities (e.g. an enterprise user or an individual user) or different types of applications (e.g. an application sensitive to seamless switching or an application sensitive to end-to-end time delay) coexist, the existing MIP communication method is unable to employ flexibly an appropriate communication mode as required.

### SUMMARY OF THE INVENTION

A first object of the present invention is to provide a communication method for a mobile terminal, so as to overcome a drawback that flexibly selecting a communication mode as required is impossible in the prior art, and to enable the selecting of a communication mode as required autonomously. The method includes:

when an application service is used by the mobile terminal for communicating with a communication peer, obtaining a communication address assigned to be used for the application service, the communication address is an Home Address or Care-of Address of the mobile terminal; and

communicating with the communication peer by using the Home Address through an Home Agent, if the obtained communication address is the Home Address; and communicating with the communication peer by using the Care-of Address, if the obtained communication address is the Care-of Address.

A second object of the present invention is to provide a network address management device, so as to overcome a drawback that flexibly selecting a communication mode as required is impossible in the prior art, and to enable the selecting of a communication mode autonomously.

The network address management device provided in the present invention includes an obtaining module and a MIP protocol module configured with the MIP protocol, where,

the MIP protocol module is configured for obtaining a CoA of a mobile terminal in a foreign network, and providing the CoA and an HoA of the mobile terminal for the obtaining module; and

the obtaining module is configured for receiving a call from an application program corresponding to an application service, obtaining a communication address that is assigned to be used for the application service, the communication address being the HoA or CoA of the mobile terminal; communicating through the MIP protocols of the MIP protocol module, when the HoA is obtained; and communicating through the CoA, when the CoA is obtained.

A third object of the present invention is to provide a mobile terminal, so as to overcome a drawback that flexibly selecting a communication mode as required is impossible in the prior art, and to enable the selecting of a communication mode as required autonomously; the mobile terminal includes an application program module, a network address management module, and a network interface module, where:

the application program module is configured with an application program, and is configured to call the network address management module through an application program corresponding to an application service when the application service is used through the mobile terminal;

the network address management module is configured to obtain a communication address that is assigned to be used for the application service according to a call from the application program module, the communication address being an HoA or a CoA of the mobile terminal; communicate with a communication peer by using the HoA through the network interface module and an HA when the HoA is obtained; and communicate with a communication peer by using the CoA through the network interface module when the CoA is obtained; and

the network interface module is configured to communicate with the communication peer according to the communication address obtained by the network address management module.

In the present invention, an HoA or a CoA is assigned to be used for an application service. When an application service is used through a mobile terminal, the mobile terminal is enabled to employ corresponding communication mode by obtaining a communication address corresponding to the application service, for example, if the HoA of the mobile terminal is obtained, a MIP communication mode is employed, that is, the HOA is used to communicate with a communication peer through an HA; and if the CoA is obtained, the normal communication mode is employed, that is, the COA is used to communicate with a communication peer. According to different demands of application services, an HoA may be assigned to be used for enterprise applications or applications sensitive to seamless switching, while a CoA may be assigned to be used for privacy applications or applications sensitive to end-to-end time delay. Thus, when various application services are used through the mobile terminal, communication modes corresponding to the respective application services may be employed to meet communication privacy requirements of the user and end-to-end time delay requirements of different types of applications. The present invention overcomes the drawback of incapability of flexibly employing a suitable communication mode depending on a specific service in the prior art, enables the selecting of an MIP communication mode or a non-MIP communication mode autonomously, and improves the service experience of a user and the flexibility of communication mode selection.

### BRIEF DESCRIPTION OF THE DRAWINGS

FIG. 1 is a schematic diagram of MIP communication in the prior art;

FIG. 2 is a flow chart of communication based on network address management in an embodiment of the present invention;

FIG. 3 is a schematic diagram of communication based on network address management in an embodiment of the present invention;

FIG. 4 is a flow chart of MIP terminal communication based on network address management in an embodiment of the present invention;

FIGS. 5a and 5b are schematic diagrams of the structure of a network address management device in an embodiment of the present invention; and

FIGS. 6a and 6b are schematic diagrams of the structure of a mobile terminal in an embodiment of the present invention.

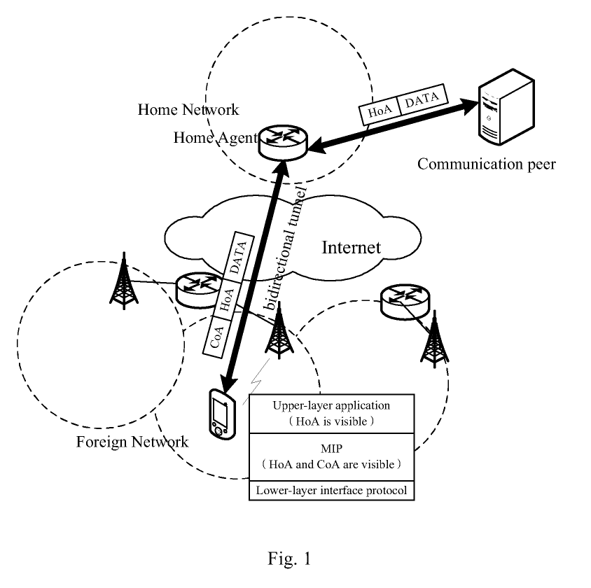

### DETAILED DESCRIPTION OF THE EMBODIMENTS

In embodiments of the present invention, function of network address management and selection is added to a mobile terminal, to enable the mobile terminal to select either an HoA and the corresponding MIP communication mode or a CoA and the corresponding normal communication mode to communicate with a communication peer, so that the freely selecting of a communication mode autonomously can be attained.

The embodiments of the present invention are described in detail hereinafter with reference to the accompanying drawings.

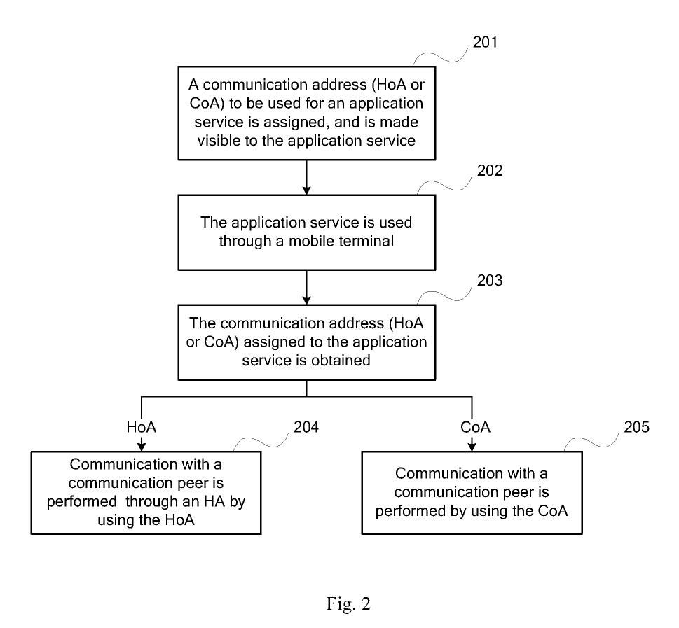

FIG. 2 shows a flow chart of communication based on network address management in an embodiment of the present invention, which includes operations 201-205 below.

At operation 201, a communication address (HoA or CoA) to be used for an application service is assigned to the application service, and is made visible to the application service.

At operation 202, the application service is used through a mobile terminal.

At operation 203, the mobile terminal obtains the communication address (HoA or CoA) assigned to the application service; if the obtained communication address is the HoA, an operation 204 is executed; and if the obtained communication address is the CoA, an operation 205 is executed.

In this embodiment, the mobile terminal provides the HoA and CoA to the service application layer of the mobile terminal, and makes the HoA and CoA visible to the service application layer, so that the mobile terminal obtains the HoA or CoA according to the communication address assigned to be used for the application service.

At operation 204, the mobile terminal communicates with a communication peer through an HA by using the HoA;

At operation 205, the mobile terminal communicates with a communication peer by using the CoA.

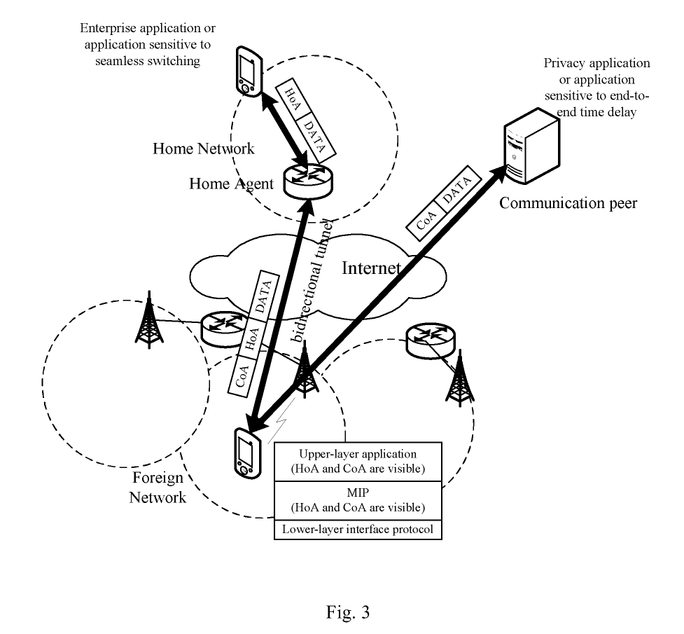

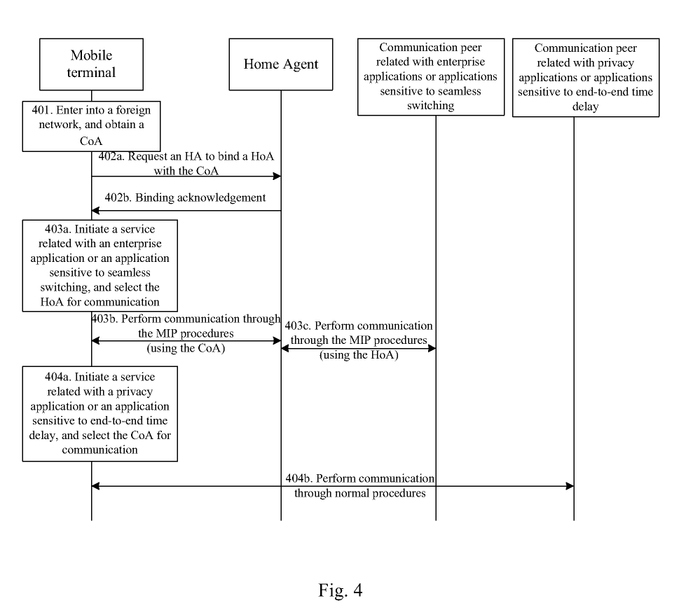

FIG. 3 illustrates a schematic diagram of communication in an embodiment of the present invention in which the function of network address management and selection is added to a mobile terminal. As shown in FIG. 3, after entering into a foreign network, the mobile terminal obtains its CoA in the foreign network, binds the obtained CoA with its HoA, provides the CoA and HoA to the upper-layer applications, and makes the CoA and HoA visible to the upper-layer applications. In this embodiment, an HoA is in advance assigned to be used for services related with enterprise applications or applications sensitive to seamless switching, while a CoA is in advance assigned to be used for services related with privacy applications or applications sensitive to end-to-end time delay. When the mobile terminal initiates a service related with the enterprise applications or applications sensitive to seamless switching, and because the HoA is used for the service and is visible to the upper-layer applications, the mobile terminal obtains the HoA and communicates with a communication peer by using the HoA in the MIP communication mode; and when the mobile terminal initiates a service related with the privacy applications or applications sensitive to end-to-end time delay, and because the CoA is used for the service and is visible to the upper-layer applications, the mobile terminal obtains the CoA and communicates directly with a communication peer by using the CoA. The above process is as shown in FIG. 4.

FIG. 4 shows is a flow chart of communication between a mobile terminal and a communication peer in an embodiment of the present invention, which includes the following operations 401-404.

At operation 401, the mobile terminal enters into a foreign network, and obtains its CoA in the foreign network;

At operations 402a to 402b, the mobile terminal requests the HA to bind the CoA with the HoA, and provides the CoA and HoA for the upper-layer applications of the mobile terminal;

At operations 403a to 403c, when the user initiates a service related with enterprise applications (e.g., logging in an internal information system of the enterprise) or applications sensitive to seamless switching (e.g., a session service), and because the HoA has been assigned to be used for the above application services in advance and is visible to the upper-layer applications, the mobile terminal obtains the HoA and communicates with a communication peer in the MIP communication mode.

In operation 403a to 403c, to transmit data from the mobile terminal to a communication peer, the mobile terminal encapsulates the service data with the HoA and CoA and transmits the encapsulated service data to the HA, the HA decapsulates the received service data and forwards the decapsulated service data to the communication peer by using the HoA; and to transmit data from the communication peer to the mobile terminal, the communication peer encapsulates service data with the HoA and transmits the encapsulated service data to the HA, the HA re-encapsulates the service data with the CoA and then transmit the re-encapsulated service data to the mobile terminal.

At operations 404a to 404b, when the user initiates a service related with privacy applications (e.g., MSN, personal mailbox) or applications sensitive to end-to-end time delay (e.g., a streaming media service), and because the CoA has been assigned to be used for the above application services in advance and is visible to the upper-layer applications, the mobile terminal obtains the CoA and directly communicates with the communication peer by using the CoA.

In operations 404a to 404b, the mobile terminal encapsulates service data with the CoA and transmits the encapsulated service data to the communication peer, and receives service data encapsulated with the CoA from the communication peer.

In the above operations, the HoA or CoA can be assigned to be used for an application service in either of the following two solutions.

Solution 1: an Application Program Interface (API) function that uses an HoA and an API function that uses a CoA are provided in a mobile terminal respectively; and a statement for calling the API function that uses the HoA and a statement for calling the API function that uses the CoA are provided in an application program. When an application service is used through the mobile terminal, the application program corresponding to the application service calls the API function that uses the HoA or the API function that uses the CoA according to the provided statements; and the called API function uses corresponding communication address and corresponding communication mode to communicate.

For an existing application service, it is possible to update the corresponding application program by replacing the statement for calling an API function in the application program with a statement for calling the API function that uses an HoA or CoA; and for a new application service, a statement for calling the API function that uses an HoA or CoA may be provided directly in the corresponding application program; so that different communication addresses are assigned to be used for different application services by providing statements for calling API functions that use different communication addresses. By assigning different communication addresses to different application services, the mobile terminal is enabled to communicate using a communication mode which is suitable for the application service.

In order to further improve flexibility, in an embodiment of the present invention, a communication address option function is provided in an application program. When a user uses an application service through a mobile terminal, the corresponding application program prompts communication address options to the user to enable the user to make a selection between the HoA and the CoA; if the HoA is selected, the application program calls the API function that uses the HoA; whereas, if the CoA is selected, the application program calls the API function that uses the CoA.

Solution 2: Application program address configuration information, which includes information on the application program and the communication address (HoA or CoA) correspondingly used by the application program, is provided. When an application service is used through a mobile terminal, the communication address (HoA or CoA) which is used by the application program is searched out and acquired through the application program address configuration information; and the mobile terminal communicates by using the obtained communication address and a communication mode corresponding to the communication address. The application program address configuration information may be provided in a mobile terminal by a user or otherwise (e.g., by downloading).

The above solution 2 implements assigning an HoA or CoA to be used for an application service, without modifying application programs and API functions; in addition, the application program address configuration information may be provided by a user, thereby enabling the user to set application program address configuration information as required or adjust application program address configuration information as the demand changes. Therefore, the implementation of the solution 2 is more convenient and flexible.

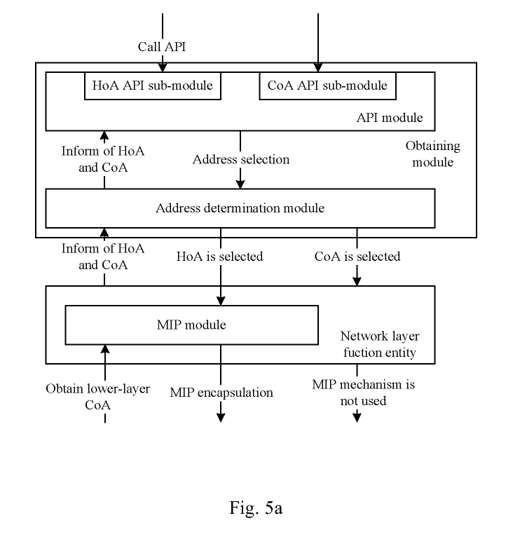

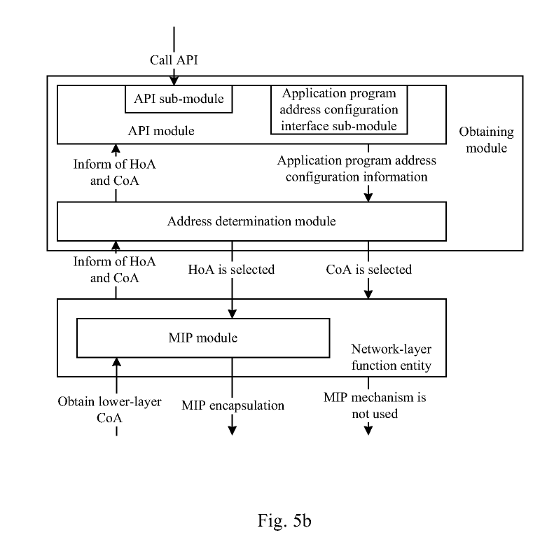

The above process of assigning an HoA or CoA for an application service and obtaining a corresponding communication address when users uses the application service may be implemented by a network address management module added to a mobile terminal; alternatively, the network address management module may be configured as a separate device, i.e., a network address management device; the network address management module makes no change to the existing protocol structure in the mobile terminal, and enables the mobile terminal to select the HoA or CoA for communication autonomously after the mobile terminal enters into a foreign network. FIGS. 5a and 5b illustrate schematic diagrams of the structure of a network address management device (module) in embodiments of the present invention, corresponding to the two implementation methods described above.

The network address management device (module) shown in FIG. 5a mainly includes: a MIP protocol module and an obtaining module. The obtaining module may include an address determination module and an Application Program Interface module.

The MIP protocol module is a function entity at the network layer, configured with MIP protocols, and configured to obtain the CoA of a mobile terminal in a foreign network when the mobile terminal enters into the foreign network and provide the CoA and the HoA of the mobile terminal to the API module through the address determination module;

The API module is configured to receive a call from an application program corresponding to an application service, and obtain a communication address (HoA or CoA) assigned to be used for the application service. The API module may include: an HoA API sub-module and a CoA API sub-module.

The HoA API sub-module is configured with an API function that uses an HoA, and is configured to call the API function according to a call instruction from the application program; and the API function takes the HoA of the mobile terminal as the communication address.

The CoA API sub-module is configured with an API function that uses a CoA, and is configured to call the API function according to a call instruction from the application program; and the API function takes the CoA of the mobile terminal as the communication address.

In the HoA API sub-module or the CoA API sub-module described above, the instruction of the application program to call the API function may be generated directly by a statement in the application program that calls the API function; or by utilizing a communication address option function in the application program to prompt a user to make a selection between the HoA and CoA, the instruction of the application program is generated from the selection result.

The address determination module is configured to, when the API module obtains the HoA, communicate with a communication peer by using the HoA and the MIP protocols of the MIP protocol module; or communicate with a communication peer by using the CoA through the network-layer function entity, when the API module obtains the CoA.

The network address management device (module) shown in FIG. 5b mainly includes: a MIP protocol module and an obtaining module. The obtaining module includes an address determination module and an application program interface (API) module.

The MIP protocol module is a network-layer function entity, configured with MIP protocols, configured to obtain the CoA of a mobile terminal in a foreign network when the mobile terminal enters into the foreign network and provide the CoA and the HoA of the mobile terminal to the API module through the address determination module;

The API module is configured to receive a call from an application program corresponding to an application service, to obtain and provide application program address configuration information for the address determination module, here, the application program address configuration information includes information on the application program and the communication address (HoA or CoA) used by the application program. The information on the application program may include an address of the application program, a port number of a Protocol Data Unit (PDU), or a process ID of the application program. The API module may include an API sub-module and an application program address configuration interface sub-module.

The API sub-module is configured with an API function, and is configured to receive the call from the application program and inform the application program address configuration interface sub-module of the call;

The application program address configuration interface sub-module is configured with information of a storage site of the application program address configuration information, and is configured to obtain the application program address configuration information from the storage site of the application program address configuration information and provide the same to the address determination module, according to the information by the API sub-module.

The address determination module is configured to obtain the communication address corresponding to the application program, on the basis of the application program address configuration information; communicate with a communication peer by using MIP protocols of the MIP protocol module, if the HoA is obtained; or communicate with a communication peer by using the CoA through the network-layer function entity, if the CoA is obtained.

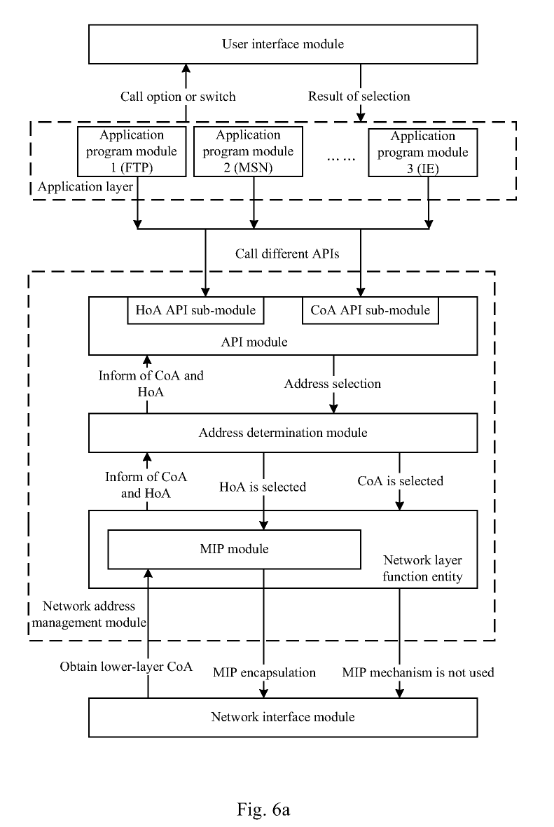

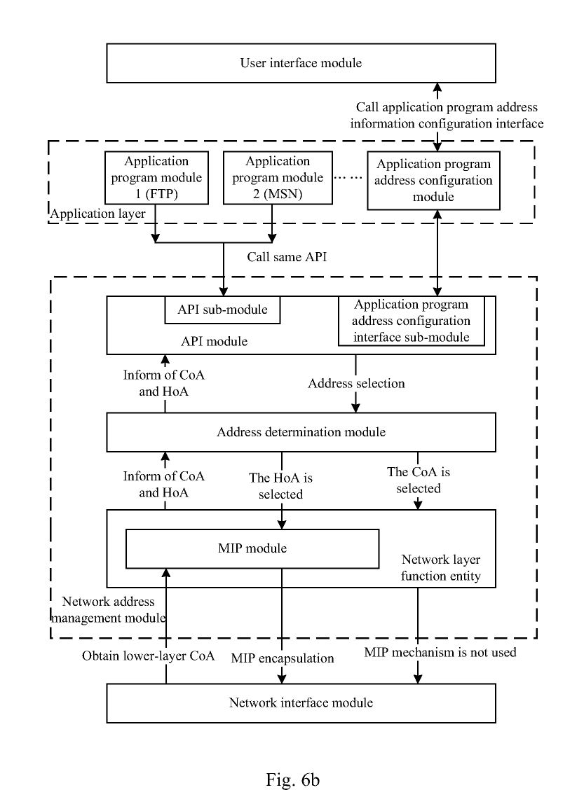

The structure of a mobile terminal configured with the network address management module shown in FIG. 5a is illustrated as in FIG. 6a; and the structure of a mobile terminal configured with the network address management module shown in FIG. 5b is illustrated as in FIG. 6b.

The mobile terminal shown in FIG. 6a includes: an application program module, a network address management module, and a network interface module.

The application program module is configured with an application program, and is configured to call the network address management module through an application program corresponding to the application service when the application service is used through the mobile terminal. A plurality of application program modules may be provided for different application services, in this case, a statement for calling an API function that uses an HoA may be provided in the application program corresponding to a service related with an enterprise application or an application sensitive to seamless switching; and a statement for calling an API function that uses a CoA may be provided in the application program corresponding to a service related with a privacy application or an application sensitive to end-to-end time delay.

The network address management module, as shown in FIG. 5a, is configured to obtain the CoA of the mobile terminal in a foreign network when the mobile terminal enters into the foreign network, and request the HA to bind the CoA with the HoA; the network address management module is also configured to receive a call from the application program module, obtain the communication address (HoA or CoA) assigned to be used for the application service, and communicate with a communication peer by using the HoA through the network interface module and the HA when the HoA is obtained, or communicate with a communication peer by using the CoA through the network interface module when the CoA is obtained.

The network interface module is configured to obtain the CoA of the mobile terminal in a foreign network when the mobile terminal enters into the foreign network and send the CoA to the network address management module; and the network interface module is also configured to communicate with a communication peer according to the communication address obtained by the network address management module and the corresponding communication mode.

When the mobile terminal as shown in FIG. 6a enters into a foreign network, the processing flows of the internal function modules in the mobile terminal are as follows.

The network interface module obtains the CoA and informs the MIP protocol module of the CoA; the MIP protocol module communicates with the HA of the mobile terminal through the network interface module, binds the CoA and the HoA of the mobile terminal at the HA, and informs the address determination module of the CoA and HoA; the address determination module records the CoA and HoA, and informs the API module of the CoA and HoA; and the API module obtains the CoA and HoA, so that the CoA and HoA of the mobile terminal are visible to the upper-layer application programs.

When a user selects an application program for communication, the corresponding application program module calls the corresponding API function in the API module; since the statement for calling the API function that uses a CoA or the API function that uses an HoA is provided in advance in the application program, the API module may call the HoA API sub-module or CoA API sub-module according to the API function indicated in the call instruction generated by the call statement so as to select the HoA or the CoA, and inform the address determination module of the selected communication address. When determining that the HoA is selected by the API module, the address determination module hands over the upper-layer PDU to the MIP protocol module for processing; the MIP protocol module processes the PDU in the MIP communication mode and hands over the processed PDU to the network interface module which in turn transmits the PDU to the communication peer. When determining that the CoA is selected by the API module, the address determination module hands over the upper-layer PDU to the network-layer function entity for processing; the network layer function entity encapsulates the PDU with the CoA and hands over the encapsulated PDU to the network interface module which in turn transmits the PDU to a communication peer.

Alternatively, an application program of the application program module may be provided with a communication address option instead of the statement for directly calling an API function that uses an HoA or CoA; the communication address option is configured to prompt a user to make a selection between the HoA and CoA for communication; thus, the API function that uses an HoA or the API function that uses a CoA may be called depending on the selection of the user; in this case, the mobile terminal may further includes a user interface module. When the application program module uses such an application program, the user interface module prompts communication address option information to the user, so that the user may make a selection between the HoA and CoA, or choose whether to enable the CoA function (which is disabled by default, that is, the HoA is used by default); and according to the selection of the user, the user interface module generates a call instruction that calls an API function, and sends the call instruction to the API module; the API module calls the corresponding HoA API sub-module or CoA API sub-module according to the API function indicated in the call instruction; in this way, the user may freely select a communication address and a corresponding communication mode autonomously to communicate with the communication peer.

The mobile terminal shown in FIG. 6 includes: an application program module, a network address management module, a network interface module, and an application program address configuration module; and the mobile terminal may further include a user interface module.

The application program address configuration module is configured with application program address configuration information, which includes the information on an application program and an communication address (HoA or CoA) corresponding to the application program; and the information on an application program may include an address of the application program, a port number used by data of the application program, or a process ID of the application program.

The application program module is configured with an application program, and is configured to utilize the application program corresponding to an application service to call the network address management module when the application service is used through the mobile terminal;

The network address management module, as shown in FIG. 5b, is configured to obtain the CoA of the mobile terminal in a foreign network when the mobile terminal enters into the foreign network, and request the HA to bind the CoA with the HoA; in addition, the network address management module is also configured to receive a call from the application program module, obtain the communication address (HoA or CoA) assigned to be used by the corresponding application program on the basis of application program address configuration information, and communicate with the communication peer by using the HoA through the network interface module and the HA when the HoA is obtained, or communicate with the communication peer by using the CoA through the network interface module when the CoA is obtained.

The network interface module is configured to obtain the CoA of the mobile terminal in a foreign network when the mobile terminal enters into the foreign network and send the CoA to the network address management module; in addition, the network interface module is also configured to communicate with the communication peer according to the communication address obtained by the network address management module and the corresponding communication mode.

When the mobile terminal as shown in FIG. 6b enters into a foreign network, the processing flows of the internal function modules in the mobile terminal are as follows.

The network interface module obtains the CoA and informs the MIP protocol module of the CoA; the MIP protocol module communicates with the HA of the mobile terminal through the network interface module, binds the CoA and HoA of the mobile terminal at the HA, and informs the address determination module of the CoA and HoA; the address determination module records the CoA and HoA, and informs the API module of the CoA and HoA; and the API module obtains the CoA and HoA, so that the CoA and HoA of the mobile terminal visible to the upper-layer application programs.

When a user selects an application program for communication, the corresponding application program module sends a call instruction to the API module; the API sub-module in the API module functions appropriately according to the call instruction, and notifies the application program address configuration interface sub-module; the application program address configuration interface sub-module obtains the application program address configuration information according to the notification and the location information of the application program address configuration module in the application program address configuration interface sub-module, and provides the application program address configuration information for the address determination module. The address determination module determines the application program address configuration information on the basis of relevant information of the application program, such as a port number of upper-layer PDU, an address of the application program, or a process ID of the application program. When determining that the communication address used by the application program is the HoA, the address determination module obtains the HoA and hands over the upper-layer PDU to the MIP protocol module for processing; the MIP protocol module encapsulates the PDU with the HoA and CoA in the MIP communication mode, and hands over the encapsulated PDU to the network interface module which in turn transmits the PDU to the communication peer. In this way, communication with the communication peer in the MIP communication mode is implemented. When determining that the communication address used by the application program is the CoA, the address determination module obtains the CoA and hands over the upper-layer PDU to the network layer function entity for processing; the network layer function entity encapsulates the PDU with the CoA, and hands over the encapsulated PDU to the network interface module which in turn transmits the PDU to the communication peer. In this way, communication with the communication peer in normal communication mode (i.e., bypass the MIP protocol stack) is implemented.

The mobile terminal shown in FIG. 6b may further include a user interface module. The application program address configuration module is an application-layer module, and is configured to set application program address configuration information; for example, an application program address information configuration interface may be provided for a user (or an operating system) by the user interface module, so that the user may set the address to be used by application program in advance. The set application program address configuration information may be stored in the form of a configuration file in the application program address configuration module or elsewhere, and the information on location of the application program address configuration information is provided for the application program address configuration interface sub-module. The application program address configuration information may include relevant information of an application program (e.g., an address of the application program, a port number of upper-layer PDU, or a process ID, etc.) and a corresponding communication address (HoA or CoA). Preferably, an HoA is configured for an application program corresponding to a service related with an enterprise application or an application sensitive to seamless switching; and a CoA is configured for an application program corresponding to a service related with a privacy application or an application sensitive to end-to-end time delay.

It should be noted that the Mobile IPv4 standard does not support the route optimization function; moreover, and the route optimization function in the Mobile IPv6 standard is disadvantageous in that a user cannot freely select a communication mode autonomously. The embodiments of the present invention are applicable to both Mobile IPv4 and Mobile IPv6 standards, and can overcome the disadvantage that the route optimization function does not support a user to freely select a communication mode autonomously.

In conclusion, in the embodiments of the present invention, a CoA is made visible to upper-layer application programs and a CoA or HoA may be selected autonomously for communication with a communication peer without modifying the hierarchy of network architecture and mobile IP; therefore, the MIP communication mode or non-MIP communication mode can be selected autonomously for communication, enabling a user to communicate with various identities (an enterprise user or an individual user) or perform various types of applications (applications sensitive to seamless switching or applications sensitive to end-to-end time delay), and achieve mutual complementation between an HoA application and a CoA application.

It shall be noted that the foregoing embodiments are merely intended to illustrate but not to limit the technical solutions of the invention. Although the invention has been detailed with reference to the foregoing embodiments thereof, those ordinarily skilled in the art shall appreciate that various modifications or alternations can be made to the technical solutions recited in the foregoing embodiments without departing from the scopes of the technical solutions in the embodiments of the invention.

1. A communication method for a mobile terminal, comprising, when an application service is used by the mobile terminal for communicating with a communication peer:
obtaining a communication address assigned to be used for the application service, the communication address being an HoA or CoA of the mobile terminal; and
communicating with the communication peer by using the HoA through an HA, if the obtained communication address is the HoA; and communicating with the communication peer by using the CoA, if the obtained communication address is the CoA.

2. The method of claim 1, wherein, assigning the communication address to be used for the application service comprises: assigning, in an application program corresponding to the application service, a communication address to be used by the application program;
obtaining the communication address assigned to be used for the application service comprises: when the application program corresponding to the application service is executed by the mobile terminal, obtaining the communication address assigned to be used by the application program according to the application program.

3. The method of claim 2, wherein, assigning the communication address to be used by the application program corresponding to the application service in the application program comprises:
providing an API function that uses the HoA or an API function that uses the CoA; and
calling the API function that uses the HoA or the API function that uses the CoA in the application program.

4. The method of claim 1, wherein, assigning the communication address to be used for the application service comprises: providing communication address options in the application program corresponding to the application service, the communication address options enabling a user to make a selection between the HoA or the CoA;
obtaining the communication address assigned to be used for the application service comprises: when the application program corresponding to the application service is executed by the mobile terminal, presenting the communication address options to the user for selecting between the HoA and the CoA by the user; and obtaining the corresponding communication address according to the selection of the user.

5. The method of claim 4, wherein, providing the communication address options in the application program corresponding to the application service comprises:
providing an API function that uses the HoA and an API function that uses the CoA respectively; and
providing communication address options in the application program, the communication address options are configured for prompting the user to make a selection between calling the API function that uses the HoA and calling the API function that uses the CoA.

6. The method of claim 1, wherein, assigning the communication address to be used for the application service comprises: setting application program address configuration information which comprises information on the application program corresponding to the application service and the communication address assigned to be used by the application program;
obtaining the communication address assigned to be used for the application service comprises: when the application program corresponding to the application service is executed by the mobile terminal, searching for the corresponding communication address in the application program address configuration information according to the information on the application program.

7. The method of claim 6, wherein, the information on the application program comprises: an address of the application program, a port number of data of the application program, or a process ID of the application program.

8. A network address management device, comprising: an obtaining module, and a MIP protocol module configured with MIP protocols, wherein,
the MIP protocol module is configured for obtaining a CoA of a mobile terminal in a foreign network, and providing the CoA and an HoA of the mobile terminal for the obtaining module; and
the obtaining module is configured for receiving a call from an application program corresponding to an application service, obtaining a communication address that is assigned to be used for the application service, the communication address being the HoA or CoA of the mobile terminal; communicating through the MIP protocols of the MIP protocol module, when the HoA is obtained; and communicating through the CoA, when the CoA is obtained.

9. The network address management device of claim 8, wherein, the obtaining module comprises an API module and an address determination module, wherein,
the API module is configured for receiving the call from the application program corresponding to the application service, and obtaining the communication address assigned to be used for the application service; and
the address determination module is configured for communicating through the MIP protocols of the MIP protocol module, when the API module obtains the HoA; and communicating through the CoA, when the API module obtains the CoA.

10. The network address management device of claim 9, wherein, the API module comprises: an HoA API sub-module and a CoA API sub-module, wherein,
the HoA API sub-module is configured with an API function that uses the HoA, and is configured to call the API function that uses the HoA according to a call instruction of the application program, the API function that uses the HoA takes the HoA of the mobile terminal as the communication address;
the CoA API sub-module is configured with an API function that uses the CoA, and is configured to call the API function that uses the CoA according to a call instruction of the application program, the API function that uses the CoA takes the CoA of the mobile terminal as the communication address;
the call instruction of the application program is generated from a statement for calling the API function in the application program; or, by prompting a user to make a selection between the HoA and the CoA according to communication address options provided in the application program, the call instruction of the application program is generated from a result of the selection.

11. (canceled)

11. The network address management device of claim 8, wherein, the obtaining module comprises an API module and an address determination module, wherein,
the API module is configured to receive the call from the application program corresponding to the application service, obtain application program address configuration information which comprises information on the application program and the communication address used by the application program, and provide the information for the address determination module; and
the address determination module is configured to obtain the communication address corresponding to the application program according to the application program address configuration information, and communicate with the MIP protocols of the MIP protocol module, when the HoA is obtained, or communicate with the CoA, when the CoA is obtained.

12. The network address management device of claim 11, wherein, the API module comprises: an API sub-module and an application program address configuration interface sub-module, wherein,
the API sub-module is configured with an API function, and is configured to receive the call from the application program and notify the application program address configuration interface sub-module; and
the application program address configuration interface sub-module is configured with information on a storage site of the application program address configuration information, and is configured to obtain the application program address configuration information from the storage site of the application program address configuration information according to the notification from the API sub-module and provide the application program address configuration information for the address determination module.

13. The network address management device of claim 11, wherein, the information on the application program comprises: an address of the application program, a port number of data of the application program, or a process ID of the application program.

14. A mobile terminal, comprising an application program module, a network address management module, and a network interface module, wherein,
the application program module is configured with an application program, and is configured to call the network address management module through an application program corresponding to an application service when the application service is used through the mobile terminal;
the network address management module is configured to obtain a communication address that is assigned to be used for the application service according to a call from the application program module, the communication address being an HoA or a CoA of the mobile terminal; communicate with a communication peer by using the HoA through the network interface module and an HA when the HoA is obtained; and communicate with a communication peer by using the CoA through the network interface module when the CoA is obtained; and
the network interface module is configured to communicate with the communication peer according to the communication address obtained by the network address management module.

15. The mobile terminal of claim 14, wherein, the network address management module comprises an API module, an address determination module, and a MIP protocol module configured with MIP protocols, wherein:
the MIP protocol module is configured to obtain the CoA of the mobile terminal in a foreign network, and provide the CoA and the HoA of the mobile terminal for the API module through the address determination module;
the API module is configured to receive the call from the application program module, and obtain the communication address assigned to be used for the application service; and
the address determination module is configured to communicate with the communication peer by using the HoA through the network interface module and the HA, when the API module obtains the HoA; or communicate with the communication peer by using the CoA through the network interface module, when the CoA is obtained.

16. The mobile terminal of claim 15, wherein, the API module comprises: an HoA API sub-module and a CoA API sub-module, wherein,
the HoA API sub-module is configured with an API function that uses the HoA, and is configured to call the API function that uses the HoA according to a call instruction generated by a statement for calling the API function that uses the HoA in the application program, the API function that uses the HoA takes the HoA of the mobile terminal as the communication address; and
the CoA API sub-module is configured with an API function that uses the CoA, and is configured to call the API function that uses the CoA according to a call instruction generated by a statement for calling the API function that uses the CoA in the application program, the API function that uses the CoA takes the CoA of the mobile terminal as the communication address.

17. The mobile terminal of claim 15, wherein, the application program in the application program module is configured with communication address options;
the mobile terminal further comprises a user interface module which is configured to prompt the communication address options to a user for making a selection between the HoA and the CoA by the user, and receive a result of the selection;
the application program module is configured to generate a call instruction for calling the corresponding API function according to the result of selection, and sends the call instruction to the API module;
the API module further comprises:
an HoA API sub-module, configured with an API function that uses the HoA, and configured to call the API function that uses the HoA according to the call instruction, the API function that uses the HoA takes the HoA of the mobile terminal as the communication address; and
a CoA API sub-module, configured with an API function that uses the CoA, and configured to call the API function that uses the CoA according to the call instruction, the API function that uses the CoA takes the CoA of the mobile terminal as the communication address.

18. The mobile terminal of claim 14, wherein, the mobile terminal further comprises an application program address configuration module configured with application program address configuration information, wherein, the application program address configuration comprises information on the application program and the communication address which is used by the application program, and the communication address is the HoA or the CoA;
the network address management module comprises: an API module, an address determination module, and a MIP protocol module configured with MIP protocols, wherein,
the MIP protocol module is configured to obtain the CoA of the mobile terminal in a foreign network, and provide the CoA and the HoA of the mobile terminal for the address determination module;
the API module is configured to receive the call from the application program module, obtain the application program address configuration information in the application program address configuration module, and provide the information for the address determination module; and
the address determination module is configured to obtain the communication address corresponding to the application service according to the application program address configuration information, and communicate with the communication peer by using the HoA through the network interface module and the HA when the HoA is obtained, or communicate with the communication peer by using the CoA through the network interface module when the CoA is obtained.

19. The mobile terminal of claim 18, wherein, the API module comprises: an API sub-module and an application program address configuration interface sub-module, wherein:
the API sub-module is configured with API functions, and is configured to receive the call from the application program and notify the application program address configuration interface sub-module of the call; and
the application program address configuration interface sub-module is configured with information on a storage site of the application program address configuration information, and is configured to obtain the application program address configuration information from the storage site of the application program address configuration information according to the notification from the API sub-module and provide the application program address configuration information for the address determination module.

20. The mobile terminal of claim 18, further comprising:
a user interface module, configured to receive application program address configuration information, and provide the application program address configuration information to the application program address configuration module.

22. (canceled)
